(19) United States
(12) Patent Application Publication
(10) Pub. No.: US 2002/0116950 A1
(43) Pub. Date: Aug. 29, 2002

(54) Heated ceramic female mold

(76) Inventors: Thomas A. Dunifon, Whitehouse, OH (US); Jennifer R. Wolfe, Curtice, OH (US)

Correspondence Address: MARSHALL & MELHORN, FOUR SEAGATE, EIGHT FLOOR, TOLEDO, OH, 43604, US

(21) Appl. No.: 09/955,795

(22) Filed: Sep. 18, 2001

Related U.S. Application Data
(60) Provisional application No. 60/271,751, filed on Feb. 27, 2001.

(51) Int. Cl. C03B 23/03

(52) U.S. Cl. 65/106; 65/273

(57) ABSTRACT

An improved female mold is used in conjunction with a heated male mold for press bending glass products, such as vehicle windshields. The female mold is made of a material having thermal expansion properties equivalent to those of the corresponding male mold, preferably ceramic and most preferably the same ceramic material as the male mold. Additionally, the female mold is preferably heated so that the glass sheet to be press bent is contacted by heated surfaces on both sides.

### CROSS REFERENCE TO RELATED APPLICATION

This application is related to the copending application entitled CONFORMALLY HEATED MALE MOLD, filed on the same date as the present invention, and having the inventors Thomas A Dunifon and Jennifer R. Wolfe. This application is hereby expressly incorporated by reference, as if set forth in its entirety herein.

### BACKGROUND OF THE INVENTION

1. Field of the Invention

The present invention relates generally to the production of curved glass sheets and, more particularly, to an improved apparatus for press bending sheets of glass.

2. Description of the Prior Art

Curved sheets of glass are commonly used as glazing closures or windows of vehicles such as automobiles and the like. For such applications, it is imperative that the sheets be bent to precisely defined curvatures determined by the configurations and sizes of the window openings as well as the overall styling of the vehicle. Further, it is required that the bent sheets meet stringent optical requirements and that the viewing area of the closures or windows be free of surface defects and optical distortion that would tend to interfere with the clear viewing therethrough. Thus, it can be appreciated that not only is it required to have bending apparatus that will shape glass sheets to precise curvatures, but also that it will do so without causing serious optical defects to the surfaces thereof.

One commercial method of producing such curved sheets generally includes heating pretrimmed, flat sheets of glass to the softening temperature, press bending the heated sheets to a desired curvature between male and female mold members having complementary shaping surfaces and, finally, cooling the curved sheets in a controlled manner to either anneal or temper the glass sheets as dictated by their intended use. Such a bending technique is referred to as “press bending” and may suitably be carried out with the glass sheets oriented vertically, horizontally or obliquely.

In a mass production operation, the above operations are carried out successively while the sheets of glass are being advanced substantially continuously along a fixed path to a heating area, a bending area, and a cooling or tempering area. To achieve satisfactory temper in a glass sheet, the temperature of the glass must be above a predetermined minimum level so as to maintain the core or central portion above a deformation temperature upon being exposed to the tempering medium. The residual heat remaining in glass sheets of conventional thickness such as those having thicknesses ranging from 0.200 to 0.255 inch (5.08 to 6.48 mm), for example, is generally above such predetermined minimum level after bending for immediate advancement to the tempering area and exposure to the tempering medium. Thus, the heat initially imparted to the sheet to bring it to the proper bending temperature can also be utilized in the final heat treating tempering operation.

In past years, the majority of laminated windshields for the automotive industry were bent by the well known gravity, or sag bending technique, wherein a pair of superimposed sheets are simultaneously bent by the forces of gravity on a suitable skeletal-type mold. The technique, although highly successful, is considerably slower and more costly than the press bending process. Moreover, recent advancements in press bending technology have resulted in most instances, in a product that is of much higher quality than that produced by gravity bending. Thus, to provide an improved product and contain costs, there has been a growing trend to bending glass for windshields, when applicable, by the press bending process.

In the typical press bending operation after the sheet is formed between the opposed bending members, the bent sheet is immediately placed on either a roll conveyor or a carrier ring for transport out of the bending station into a cooling station. The lower, or female, press member is generally of ring-type construction and in the first method supports the sheet after bending and deposits it on the roll conveyor as the press member is lowered beneath the rolls. The sheet in the latter method is supported by an upper vacuum mold and deposited on the carrier ring immediately after bending. In either instance, during the initial cooling stage the perimeter of the hot glass sheet is in contact with a cooler, substantially continuous ring which accelerates cooling at the edges of the sheet relative to the central portion. This differential cooling has an effect on the ultimate stress pattern established in the sheet after it attains room temperature. When press bending thin glass sheets for windshields, this can result in permanent high stress areas inwardly of the peripheral edge of the sheet which increases the likelihood of breakage resulting from chipping, abrasions, stone hits and the like, during subsequent use in automobiles.

U.S. Pat. No. 5,279,635 to Flaugher et al., illustrates a method an apparatus for a press bending process. This patent, which is hereby incorporated by reference in its entirety herein, illustrates a process and method for press bending glass articles.

U.S. Pat. No. 3,854,920 to Kay et al., applies complementary bending surfaces at substantially the bending temperature of the glass and maintains those temperatures for a time sufficient to permit decay of thermal inhomogeneities and bending stresses.

U.S. Pat. No. 5,009,694 to Nishitani et al. discloses a method for heat treating a glass plate which strengthens a peripheral region and anneals the central region. A heated glass plate is placed on a ring-like holder which is maintained at a temperature lower than that of the glass plate.

U.S. Pat. No. 5,178,660 to Wampler et al. discloses a female press bending ring for press bending glass sheets. The ring is heated during the bending cycle to regulate the transfer of heat between the peripheral region of the glass and the female bending ring to reduce near-edge tension and edge stresses.

The above discussed inventions are limited as discussed in regard to the temperature differences between the male mold and female mold. Additionally, heating the female mold can be problematical because of different thermal expansion characteristics between the male and female molds, causing the molds to expand at different rates upon heating, which can be detrimental to the forming of the glass.

### SUMMARY OF THE INVENTION

The present invention alleviates the above-noted shortcomings of the known devices by providing an improved female mold which includes heating elements in addition to the heating elements of the male mold, to heat the female mold as the male mold is heated. Additionally, the female mold is preferably made of a material having the same expansion characteristics as the material of the male mold, even more preferably the same material as the male mold. Most preferably, the female and male molds are each made of the same ceramic material.

### BRIEF DESCRIPTION OF THE DRAWINGS

In the drawings, wherein like numerals refer to like parts throughout:

FIG. 1 is a perspective view of male and female molds in accordance with the invention for press bending glass;

FIG. 2 is a plan view of the female mold of the present invention shown with a glass sheet supported thereon;

FIG. 3 is a side elevational view of the female mold with certain parts broken away, taken substantially along line 3-3 of FIG. 1;

FIG. 4 is a sectional view of the female mold taken along line 4-4 of FIG. 3; and

FIG. 5 is a sectional view similar to FIG. 4 which illustrates an alternative embodiment of the heating elements shown in FIG. 4.

### DETAILED DESCRIPTION OF THE PREFERRED EMBODIMENT

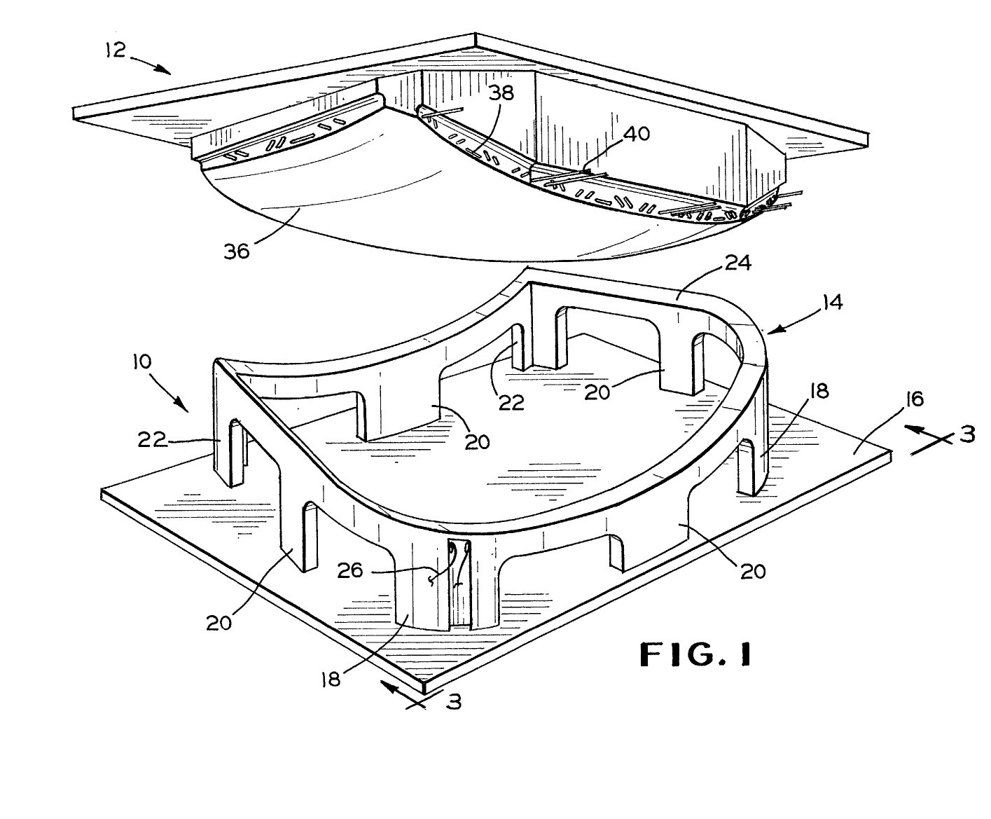

With reference now to the drawings, there is illustrated in FIG. 1 a female mold 10 and a male mold 12 used for press bending a glass sheet. The male mold 12 is preferably a conformally heated male mold of the type defined in the co-pending application filed on the same date as the present application. The male mold includes a pressing surface 36 to press glass sheets into the desired configuration. Conformal heating wires 38 project through the male mold 12 to heat the male mold to the desired temperature. Electrical leads 40 provide connections for the male mold. The male mold is preferably formed of a ceramic material.

The female mold 10, according to the present invention, includes a female ring 14 for pressing the glass sheet against the male mold. The ring is formed with a pressing surface 24 for contacting a glass sheet to be bent. As opposed to the pressing surface of the male mold 36 which preferably forms a contiguous surface, the pressing surface of the female mold 24 instead is in the form of a ring leaving a relatively large opening surrounded by the pressing surface 24. The pressing surface 24 can be covered by a cover as is known in the art.

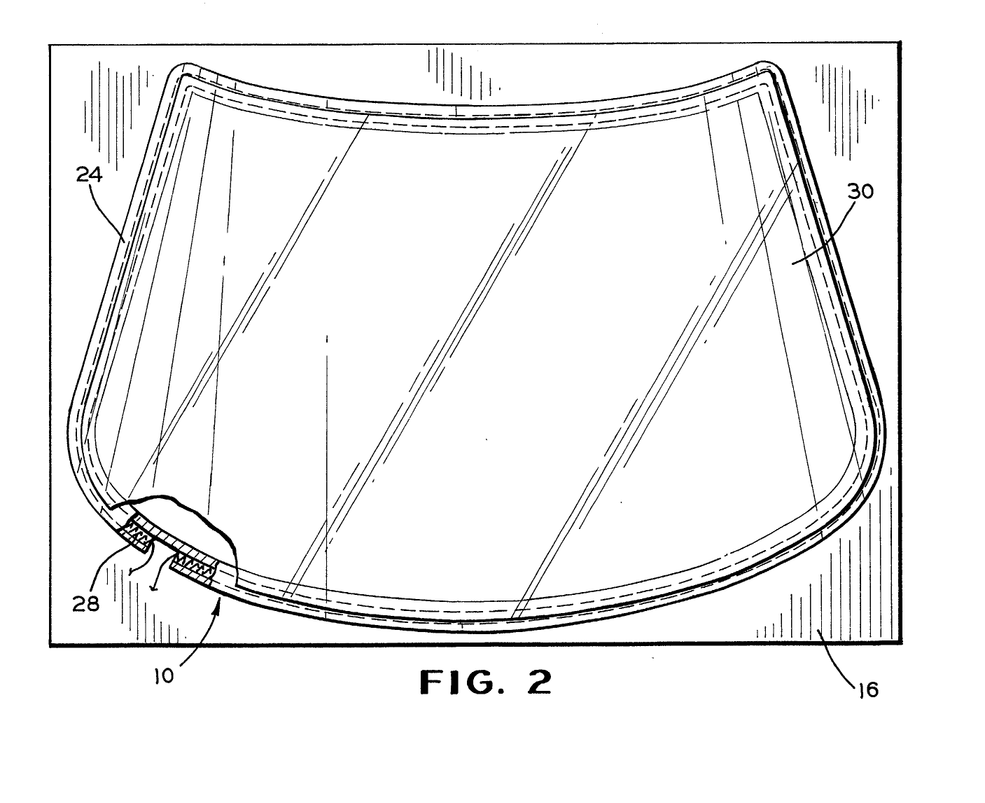

The ring 14 is preferably supported on a base 16 by a set of legs 18, 20, 22. At the corners of the female mold 10 which will form the top of the glass sheet are legs 22, which are preferably angled, extending along both the sides and bottom of the ring 14. The angle formed by the sections of the legs is dependent upon the shape of the formed glass sheet desired. As depicted in this figure, acute angles are formed. At the corners of the female mold 10 forming the bottom of the glass sheet, are legs 18 which are preferably rounded, with portions proceeding along the top edge of the mold and along the sides of the mold. To provide additional support for the ring 14, additional legs 20 can be provided between the corners of the mold. FIG. 1 also illustrates a possible location for electrical leads 26 for connection to heating elements (see FIG. 2) for heating the female mold 10.

FIG. 2 shows a view of the female mold 10 with a glass sheet 30 depicted in position for press bending. Additionally, a cut-away portion of the glass sheet illustrates a possible embodiment of a heating element 28 for use in heating the female mold 10. The heating elements 28 can be any standard form of heating elements customarily used in the art, for example, heating elements made of nickel chromium (ni-chrome) alloys. The size of the glass sheet 30 to be pressed will vary based upon the dimensions of the final product required, as will the shape and size of the female ring 14 and the surface 24.

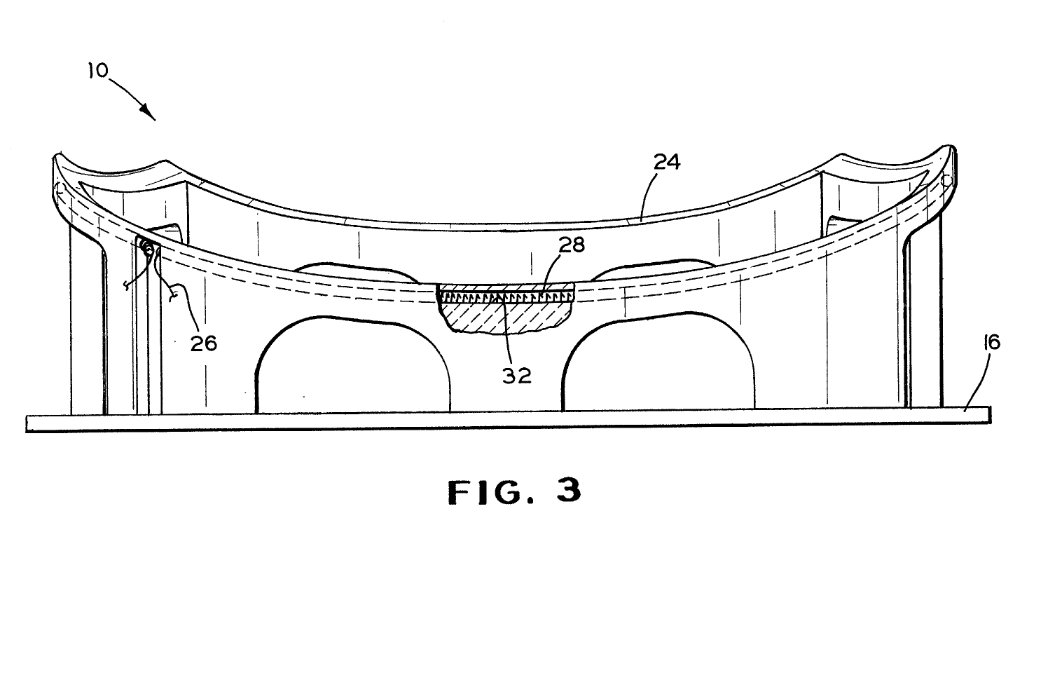

FIG. 3 depicts an additional view of an embodiment of a female mold 10 as described in the present invention, depicting a side view of the mold. In this view, the portion of the mold which will form the bottom of the pressed glass sheet is shown.

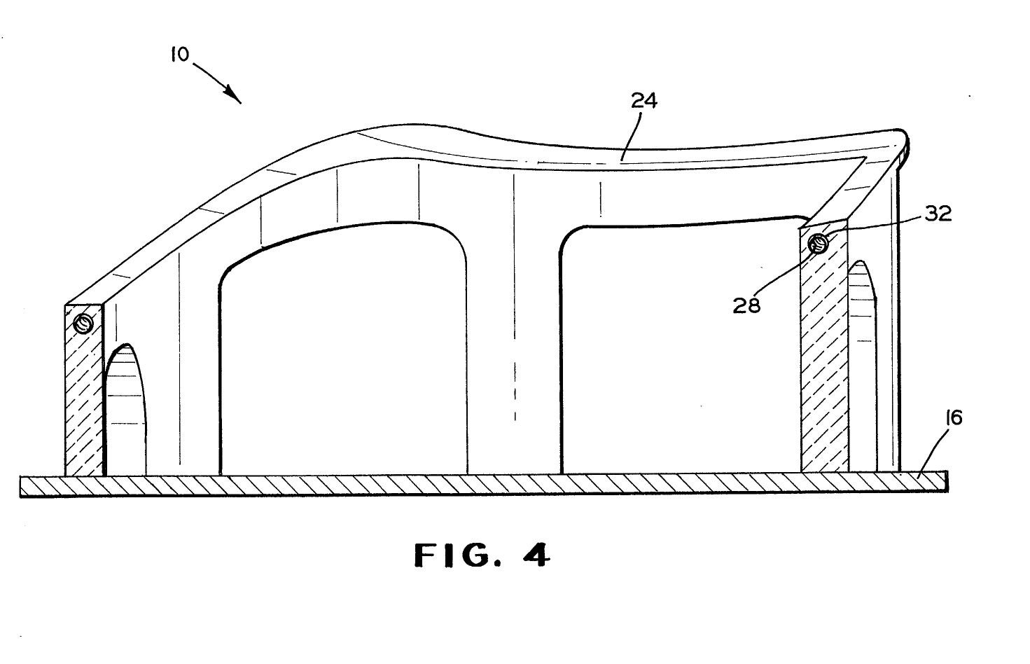

FIG. 4 shows a sectional view of the female mold 10, illustrating a preferred embodiment of the heating element 28. As can be seen in this Figure, the heating element 28 passes through a hole or channel 32 formed in the female mold 10. The channel 32 can be formed by a method conventional in the art. The heating element 28 is preferably disposed near the surface 24 to provide better heat transfer to the glass sheet.

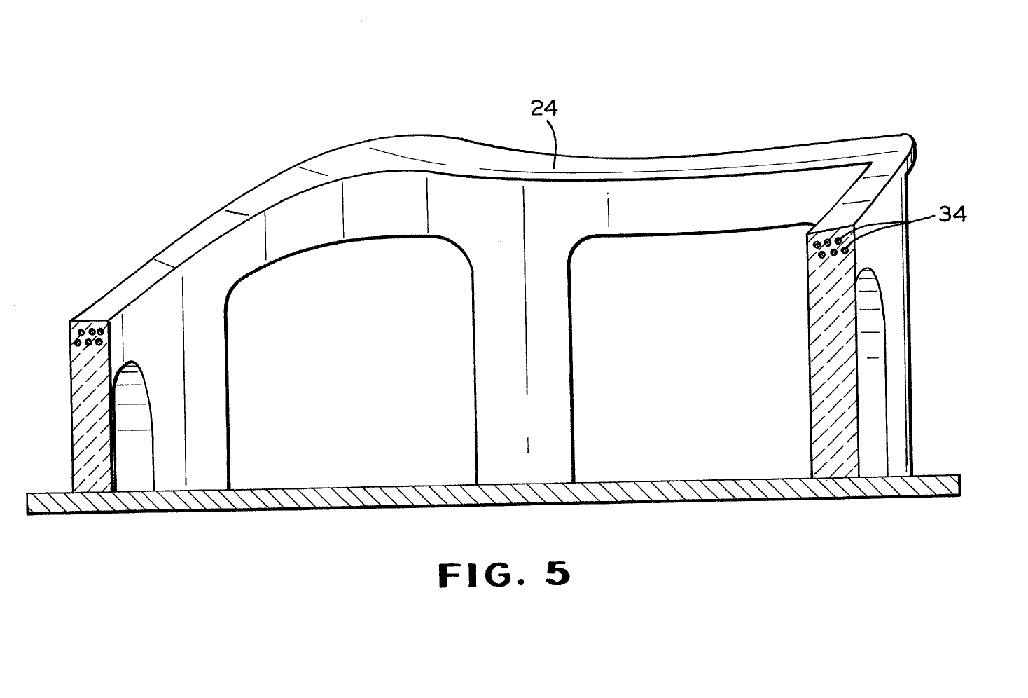

FIG. 5 shows the same sectional view shown in FIG. 4, illustrating an alternative embodiment of the heating elements. In this figure, the heating element is shown as a series of heating wires 34, which preferably substantially conform to the surface 24 of the female mold 10. This embodiment can provide a more even temperature profile at the surface 24 of the mold 10.

The present invention is presently believed to be most advantageous for the manufacture of vehicle windshields. It is possible, within the scope of the present invention, for the device to also be utilized in the preparation of vehicle backlights and sidelights.

The ceramic material used in at least one embodiment of the present invention for a cast ceramic female mold has a very low coefficient of thermal expansion. Because of this low coefficient of thermal expansion, almost no change in size or shape results as the mold is heated from about 0° C. to about 750° C. Extremely high cast ceramic female mold temperatures can be achieved.

It is to be understood that the form of the invention herein shown and described is to be taken as a preferred embodiment only of the same, and that various changes in the size, shape and arrangement of parts, as well as various procedural changes may be made without departing from the spirit of the invention or the scope of the following claims.

What is claimed is:

1. An apparatus for press bending glass sheets comprising:
a heated male mold and a female mold positioned to press a glass sheet between them;
said male mold and said female mold being made from substantially the same material; and
said female mold including at least one heating element disposed within said female mold.

2. The apparatus according to claim 1, wherein said at least one heating element is configured to heat said female mold to approximately the temperature of said male mold.

3. The apparatus according to claim 1, wherein the material of the male mold and the material of the female mold have essentially the same thermal expansion characteristics.

4. The apparatus according to claim 1, wherein the material of the female mold is comprised of a ceramic.

5. The apparatus according to claim 1, wherein the male mold and the female mold are made from the same material.

6. An apparatus for press bending glass sheets comprising:
a heated male mold and a female mold, said molds having complementary shaping surfaces and being positioned to press a glass sheet between them, said male mold adapted to be heated to an operating temperature for press bending glass sheets;
said female mold being made from a material having thermal expansion characteristics substantially similar to those of the male mold; and
said female mold comprising at least one heating element disposed within said female mold to heat said female mold to about said operating temperature of said male mold.

7. An apparatus for press bending glass sheets comprising a female ring, which is comprised of a ceramic material.

8. The apparatus according to claim 7 further comprising at least one heating element disposed within said female ring.

9. A method of press bending glass sheets comprising the steps of:
providing a heated male mold and a female mold positioned to press a glass sheet between them, said male mold and said female mold being made from substantially the same material, said female mold including at least one heating element disposed within said female mold; and
pressing a glass sheet between said male mold and said female mold.

10. The method according to claim 9, wherein said at least one heating element is configured to heat said female mold to approximately the temperature of said male mold.

11. The method according to claim 9, wherein the material of the male mold and the material of the female mold have essentially the same thermal expansion characteristics.

12. The method according to claim 9, wherein the material of the female mold is comprised of a ceramic.

13. The method according to claim 9, wherein the male mold and the female mold are made from the same material.

14. A method for press bending glass sheets comprising the steps of:
providing a heated male mold and a female mold, said molds having complementary shaping surfaces and being positioned to press a glass sheet between them, said male mold adapted to be heated to an operating temperature for press bending glass sheets, said female mold being made from a material having thermal expansion characteristics substantially similar to those of the male mold, said female mold further comprising at least one heating element disposed within said female mold to heat said female mold to about said operating temperature of said male mold; and
pressing a glass sheet between said male mold and said female mold.

15. A method for press bending glass sheets comprising the steps of:
providing a male mold and a female ring, which female ring is comprised of a ceramic material; and
pressing a sheet of glass between said male mold and said female ring.

16. The method according to the claim 15 wherein said female ring includes at least one heating element disposed within said female ring.
